(19) United States
(12) Patent Application Publication
(10) Pub. No.: US 2015/0286115 A1
(43) Pub. Date: Oct. 8, 2015

(54) MOUNT, AND SET COMPRISING A MOUNT

(71) Applicant: TORMAXX GMBH, Möenchengladbach (DE)

(72) Inventor: Hubert Koch, Moenchengladbach (DE)

(73) Assignee: Tormaxx GmbH, Moenchengladbach (DE)

(21) Appl. No.: 14/437,332

(22) PCT Filed: Oct. 28, 2013
(86) PCT No.: PCT/DE2013/000632

§ 371 Date: Apr. 21, 2015

Related U.S. Application Data
(60) Provisional application No. 61/809,517, filed on Apr. 8, 2013.

(30) Foreign Application Priority Data
Oct. 26, 2012 (DE) 10 2012 021 009.4
Apr. 5, 2013 (DE) 10 2013 005 766.3

(51) Int. Cl. G03B 17/56; F16F 7/00; H04N 5/225; F16M 13/02

(52) U.S. Cl. CPC G03B 17/561; F16M 13/022; F16F 7/00; H04N 5/2253

(57) ABSTRACT

A mount for electric devices, in particular cameras such as action cameras, as well as sets including such a mount, has a tube clamp that has two clamp elements which are connected to one another by a hinge, the hinge being a flexible hinge. The flexible hinge may have a connection element connected with the clamp element in such a manner that it is interchangeable.

The invention relates to a mounting for attachment of an electric device, particularly of a camera to a rod, and to a set having such a mount.

Mounts for attachment of electric devices, particularly of cameras, such as, for example, action cameras, are numerously known from the state of the art. These allow attachment of a plastic mount to a helmet, to bicycle handlebars, to an exterior mirror or to a ship's mast, for example, using adjustable silicon bands of different lengths.

It is the task of the present invention to improve such apparatuses known from the state of the art.

This task is accomplished, according to a first aspect of the invention, by means of a mount for attachment of an electric device, particularly of a camera on a rod, wherein the mount has a pipe clip having two clip elements, which are connected with a hinge, wherein the hinge is a flexible hinge. Other objects can also be attached using the mount, such as, for example, a lamp or a measurement device. Attachment of a mechanical apparatus is also possible. In this connection, a rod is understood to be a rod-shaped apparatus, such as, for example, specifically a strut of a helmet, a bicycle handlebar, a saddle tube, a component of a tripod or a ship's mast. A flexible hinge is understood to be a hinge that can bridge different distances between the two clip elements. Thus, it is possible to affix the mount to rods having different diameters. Thus, the diameter of a saddle tube is on the order of 25 mm, for example, that of a ship's mast is on the order of 60 mm or more. The mount can be adapted to these by means of the flexible hinge. Thus, great variability of the mount is guaranteed.

It is advantageous if the flexible hinge has a connection element and this element is connected with the clip elements in such a manner that it is interchangeable. Such an interchangeable connection element is a possibility for configuring a flexible hinge. If multiple connection elements are included in a set having a mount, then the hinge distance can be changed by means of replacing the connection element. In particular, a part of the clip element body can be removed, so that the mounting of the connection element in the clip element is exposed. The connection element can then be replaced and the clip element body can be closed again. This can be done, for example, by means of an attachment with a screw.

On a side opposite the hinge, the mount can have a spindle rod having a closure lever on a first clip element, and a fork on a second clip element, wherein the spindle rod engages into the fork with the closure lever, with shape fit, in the closed state of the mount.

By means of the spindle rod, length adjustability is also guaranteed on the side opposite the hinge. Thus it is ensured that here, too, adaptation of the mount to different diameters of a rod-shaped apparatus is possible. Other closure mechanisms on the side opposite the hinge, which mechanisms guarantee length adjustability, are also conceivable, for example a rod with gear teeth, a cable, or a threaded rod.

To facilitate closing, a plastic element can be disposed between the clip element and the closure lever, in order to reduce the friction of the two surfaces that are composed of identical material.

It is advantageous if a cushioning element is disposed on the inside of a clip element. In this way, cushioning of vibrations of the rod can take place.

It is advantageous if the cushioning element is attached in interchangeable manner. In this way, it is possible to adapt the cushioning element to stress situations.

The mount can have a holder for an electronic device. This can particularly be a camera holder. This can be attached to one of the clip elements. In this connection, a holder for an electronic device is understood to mean any apparatus that is suitable for attaching such a device to the mount.

Furthermore, the mount can also have holders for other apparatuses. An accommodation bore in which a device or further objects can be attached is also advantageous.

In particular, the clip element can have a ball pan into which the holder for an electronic device engages with a ball head.

It is advantageous if a fixation element acts on the ball head in the ball pan. In this connection, a fixation element is understood to mean any apparatus that fixes the ball head in place in a specific position. This can be, for example, a screw, a clamping lever or a rotation apparatus, which act on the ball head in the ball pan.

It is advantageous if pivot recesses are provided in the ball pan. In this way, the mount can be pivoted into extreme angles in specific directions. For example, the pivot recesses can be disposed at a 90° angle. In this way, the significant spatial directions are covered well.

It is particularly advantageous and independently inventive if the holder has a device accommodation, wherein the device accommodation has a slot, and a wall of the slot has a notch on a side of the wall facing away from the slot. An attachment apparatus affixed to the electric device can be introduced into such a device accommodation and attached in the slot. It is advantageous if the device accommodation has multiple slots. These can interact, accordingly, with multiple plate-shaped elements on a device attachment apparatus. In this connection, multiple slots increase the stability of the interaction. In this connection, the attachment apparatus on the device can be configured in plate shape, in such a manner that a plate engages into the slot with shape fit and/or force fit. Both the walls of the slot and also the attachment apparatus on the camera can have a bore, for example. A rotation apparatus can be guided through this bore, the apparatus connects the walls of the slot with one another and can be configured in such a manner that it pulls against the attachment device of the electronic device. In this connection, the notch provided on the outside of a wall has the advantage that this wall can be more easily deformed and therefore will lie better against the attachment apparatus of the electric device. In this connection, multiple notches on all the walls, particularly the outer walls of the device accommodation, as well as multiple slots on a wall of the slot can be advantageous. It is advantageous if the notch is disposed at the lower end of the wall, at the level of the lower end of the slot.

Individual elements or all the elements of the mount can be made from aluminum. This high-quality material demonstrates little wear and is very stable in comparison with the state of the art, such as, for example, plastic. This is particularly advantageous in the extreme sports sector.

A further aspect of the invention relates to a set having a mount, wherein it has a mount and connection elements of different lengths. In this way, a shorter, a medium-length, and a long connection element can be provided, in order to cover different rod diameters.

A last aspect of the invention relates to a set having a mount and cushioning elements having different degrees of cushioning. By means of different degrees of cushioning, it is possible to adapt the set to different conditions of use. For example, the quality of vibrations that occur during mountain biking, for example, varies greatly, and is significantly different from a stress that occurs during sailing, for example.

It is advantageous if the cushioning elements are marked with different colors, in order to guarantee easier recognizability of the different degrees of cushioning. In particular, the cushioning elements can all be produced from plastics of different colors.

The invention will be described in greater detail below, using exemplary embodiments, making reference to the drawing.

This shows:

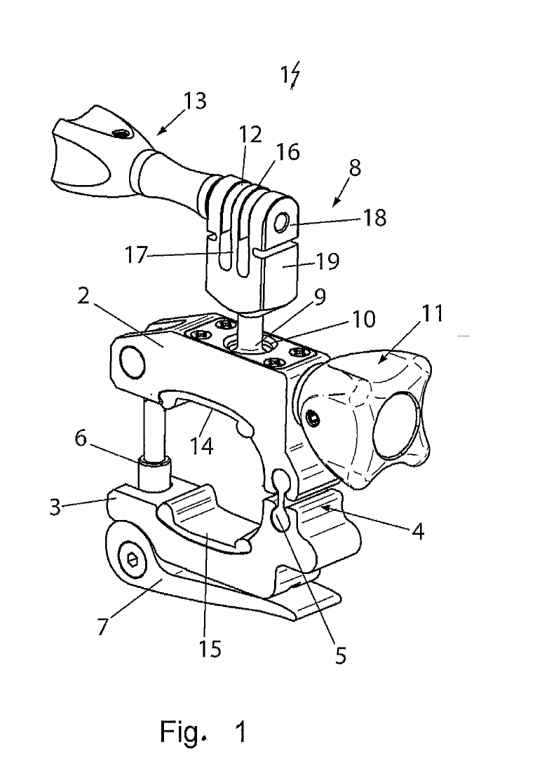

FIG. 1 a three-dimensional representation of a mount having a holder for an electronic device, wherein this holder is fixed in place by means of a rotation device,

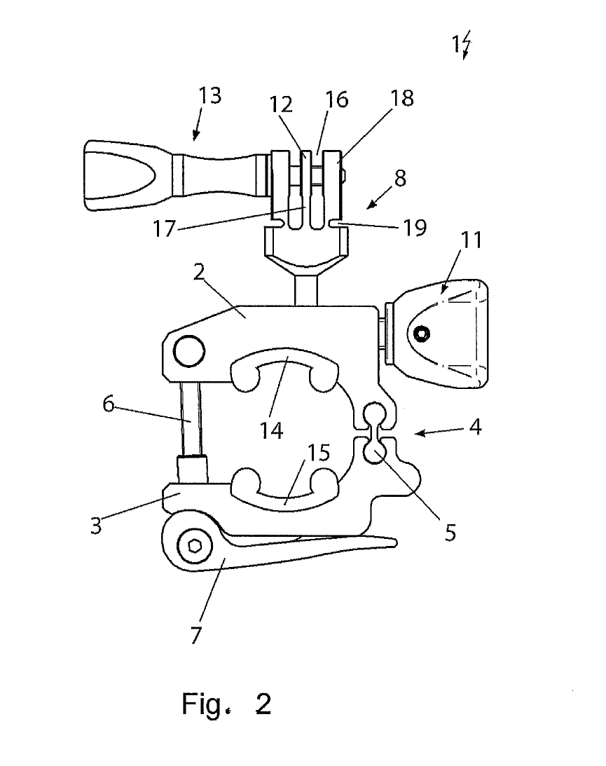

FIG. 2 a side view of a mount having a holder for an electronic device, wherein the holder is fixed in place by means of a rotation device,

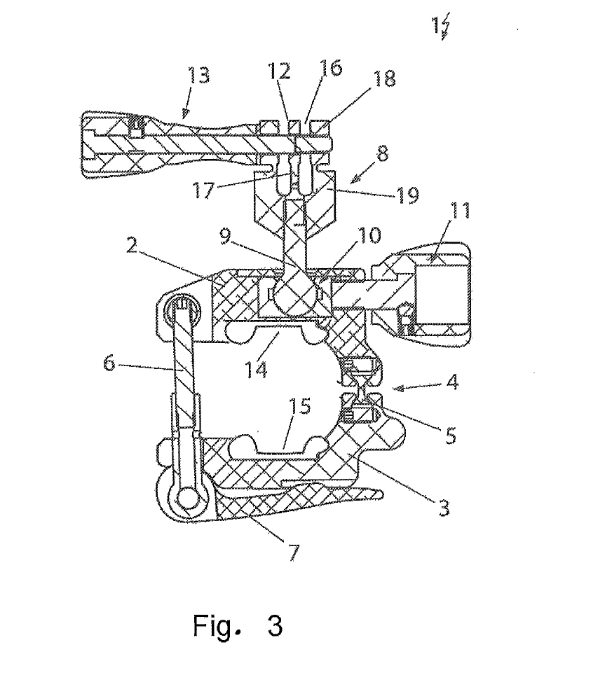

FIG. 3 a section through a mount having a holder for an electronic device, wherein the holder is fixed in place by means of a rotation device,

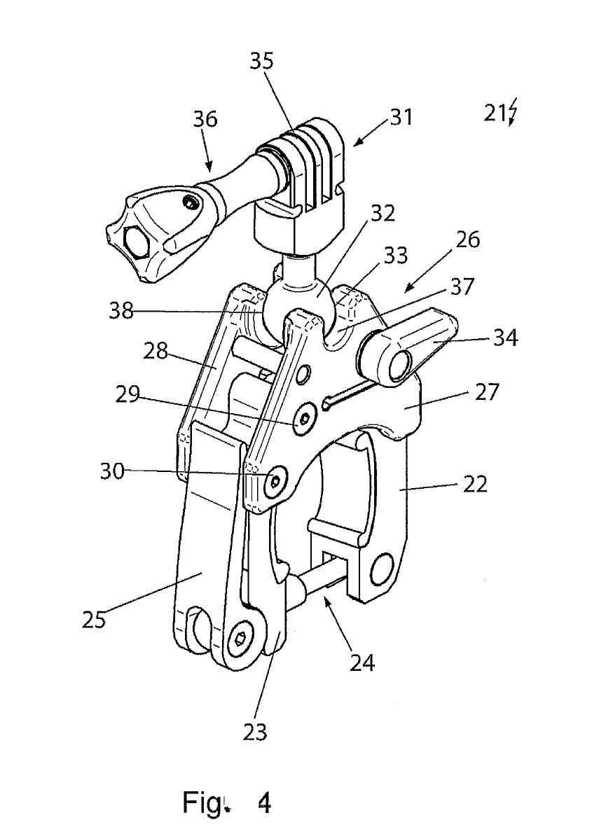

FIG. 4 a three-dimensional representation of a mount having a holder for an electronic device, wherein the holder is fixed in place using a clamping lever,

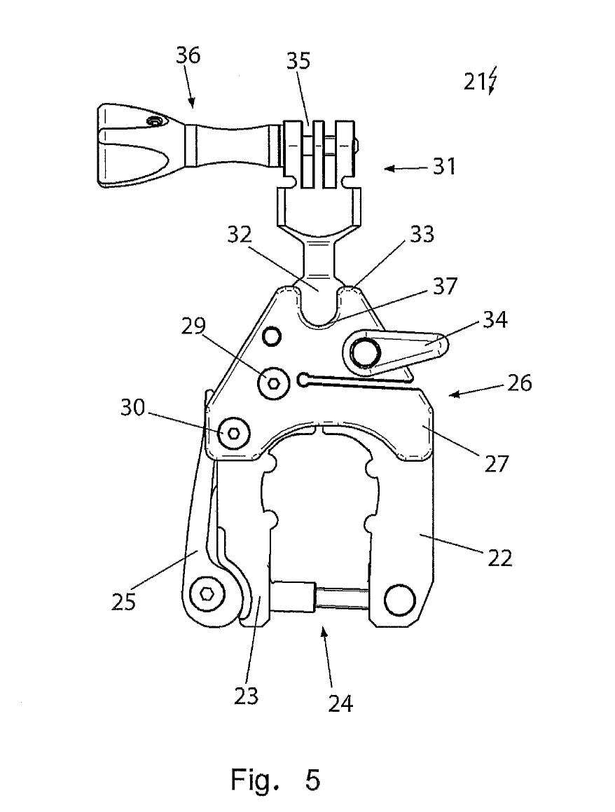

FIG. 5 a side view of a mount having a holder for an electronic device, wherein the holder is fixed in place using a clamping lever,

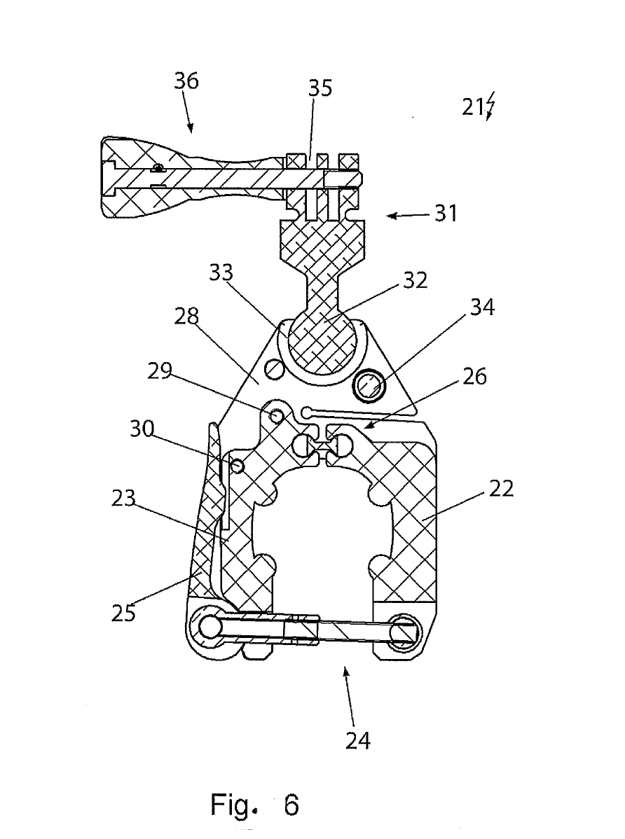

FIG. 6 a cross-section through a mount having a holder for an electronic device, wherein the holder is fixed in place using a clamping lever, and

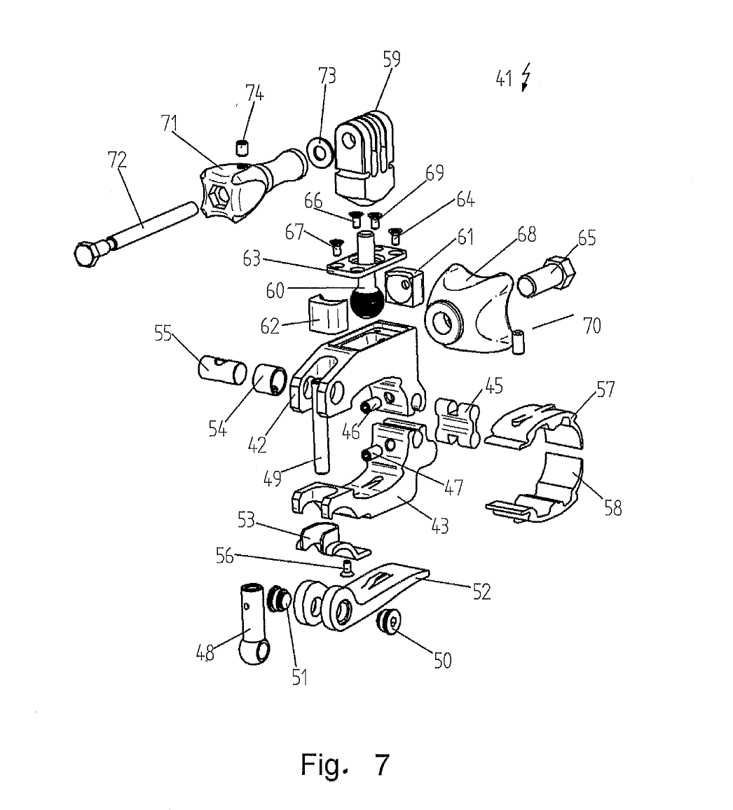

FIG. 7 an exploded drawing of a mount having a holder for an electronic device, wherein the holder is fixed in place by means of a rotation device.

The mount 1 in FIGS. 1 to 3 has two clip elements 2 and 3, which are connected by way of a flexible hinge 4. This flexible hinge 4 makes it possible to change the distance between the two clip elements 2 and 3, and to thereby adapt the mount 1 to different diameters of the object to which it is being attached. In this connection, the flexible hinge 4 has a connection element 5. This connection element 5 is connected with the clip elements in such a manner that it is interchangeable. An adjustment spindle 6 is provided on the side opposite the flexible hinge, which spindle connects the upper clip element 2 with the lower clip element 3. The adjustment spindle is fixed in place in its position by means of a clamping lever 7. A camera holder 8 is disposed in the upper clip element 2. This holder engages into a ball accommodation 10 with a ball head 9. In this accommodation, the ball head 9 can be fixed in place by means of a fixation element 11 of the camera holder 8. In the present case, this fixation element 11 is a rotation apparatus. The camera itself (not shown) is attached to the camera holder 8 by means of a camera accommodation 12. For this purpose, a rotation apparatus 13 can be moved out of the camera accommodation. A camera (not shown) having a suitable apparatus (not shown) can be set into the accommodation and then the latter can be closed. In this connection, the camera accommodation has two slots like the slot 16. This slot is delimited by two walls 17 and 18. These walls are connected with one another and pulled against one another by means of the rotation apparatus 13. In order to facilitate this, the wall 18 has a notch 19 at the level of the lower end of the slot. By means of this notch, the wall 18 becomes more flexible and can thereby be better pulled against an attachment apparatus of a camera (not shown) that engages into the slot. Interchangeable cushioning elements 14, 15 offer sufficient cushioning between mount 1 and an object (not shown) to which the mount is attached.

In the case of a mount 21 as shown in FIGS. 4 to 6, the two clip elements 22 and 23 are once again connected on one side by way of a fixation spindle 24, which can be fixed in place by means of a closure lever 25. A flexible hinge 26 is situated on the opposite side. This hinge is disposed between two holding and fixation plates 27 and 28, of which the attachment plate 27 can be removed by means of the attachment screws 29 and 30. In this way, the connection element can be replaced. This mount 21 also has a camera holder 31. This holder engages into a ball pan 33 with a ball head 32. Here, attachment of the ball head 32 in the ball pan 33 takes place by means of a clamping lever 34. Here, too, the camera can be inserted into the camera accommodation 35 in that the fixation element 36 is moved out of the camera accommodation. The ball pan 33 has pivot recesses such as, for example, the pivot recesses 37, 38, so that the camera holder 31 can be pivoted by up to 90°.

The mount 41 in FIG. 7 has two clip elements 42 and 43, which can be connected by way of a flexible hinge. This flexible hinge consists of the connection element 45, which is held in the clip elements 42, 43 by means of two attachment screw elements 46, 47. By means of unscrewing these attachment screw elements 46, 47, the connection element 45 can be pushed out of the clip elements 42, 43 and replaced with another connection element (not shown). The adjustment spindle, which is provided on the side opposite the flexible hinge, is composed of a spindle thread 48 and a spindle screw 49, which are connected with a closure lever 52 by way of articulated components 50 and 51. A plastic element 53 is disposed between the clip element 43 and the closure lever 52, which element ensures that the closure lever 52 can easily be closed against the clip element 43, in which the adjustment spindle engages into a fork, by means of a reduction in friction. This plastic element 53 is connected with the clip element 43 by means of a screw 46. On the side of the clip element 42, the screw element 49 engages into closure elements 54, 55. Cushioning elements 57, 58 are disposed on the inside of the clip elements 42 and 43. These cushioning elements are configured to be interchangeable and can be inserted into the clip elements 42, 43 as the result of their shape, and hold in the clip elements with shape fit and force fit. Adapted cushioning between the mount 41 and an object to which the mount is attached (not shown) can be guaranteed by means of different degrees of cushioning of different cushioning elements 57, 58. A camera holding element 59 is connected by means of a thread of a ball-head rod 60. This ball-head rod having the thread, on the one hand, and a ball head, on the other hand, is enclosed by two ball accommodation elements 61, 62, which are held in a recess in the upper clip element 42 by means of a cover plate 63. The cover plate 63 is attached to the clip element 42 by means of the screws 64, 65, 66, and 67. A rotation apparatus having a rotation button 68 and a screw 69 countersunk into this button, which is attached in the rotation knob by means of a screw element 70, serves as a fixation device. A camera is inserted into a camera accommodation 59, in that the rotation apparatus 71 is unscrewed accordingly. This is done by way of the screw element 72, on which the washer 73 is disposed between the rotation apparatus 71 and the camera accommodation 59. The latter is held in the rotation apparatus 71 by means of the screw element 74.

1. Mount for attachment of an electric device, particularly of a camera on a rod, wherein the mount has a pipe clip having two clip elements, which are connected with a hinge, wherein the hinge is a flexible hinge.

2. Mount according to claim 1, wherein the flexible hinge has a connection element and wherein this element is connected with the clip elements in such a manner that it is interchangeable.

3. Mount according to claim 1, wherein the mount, on a side that lies opposite the hinge, has a spindle rod having a closure lever on a first clip element, and a fork on a second clip element, wherein the spindle rod engages into the fork, with shape fit, in the closed state of the mount.

4. Mount according to claim 1, wherein a cushioning element is disposed on the inner side of a clip element.

5. Mount according to claim 4, wherein the cushioning element is interchangeable.

6. Mount according to claim 1, wherein it has a holder for an electronic device, particularly a camera.

7. Mount according to claim 6, wherein a clip element of the mount has a ball pan, into which the holder engages with a ball head.

8. Mount according to claim 6, wherein a fixation element acts on the ball head in the ball pan.

9. Mount according to claim 8, wherein pivot recesses are provided in the ball pan.

10. Mount according to claim 9, wherein the pivot recesses are disposed at a 90° angle.

11. Mount particularly according to claim 6, wherein the holder has a device accommodation, wherein the device accommodation has a slot, and a wall of the slot has a notch on a side of the wall facing away from the slot.

12. Mount according to claim 1, wherein individual elements or all the elements of the mount comprise aluminum.

13. Set having a mount according to claim 1, wherein it has a mount and connection elements having different lengths.

14. Set according to claim 12, wherein it has a mount and cushioning elements having different degrees of cushioning.

15. Set according to claim 12, wherein the cushioning elements are marked with different colors.
